(19) United States
(12) Patent Application Publication
(10) Pub. No.: US 2026/0257579 A1
(43) Pub. Date: Sep. 3, 2026

(54) CHARGING SYSTEM FOR ELECTRIC VEHICLE, AND ELECTRIC VEHICLE

(71) Applicant: SUBARU CORPORATION, Tokyo (JP)

(72) Inventor: Kazu HAMADA, Tokyo (JP)

(21) Appl. No.: 18/875,312

(22) PCT Filed: Sep. 22, 2023
(86) PCT No.: PCT/JP2023/034549

§ 371 Date: Dec. 16, 2024

(51) Int. Cl. B60L 53/62

(52) U.S. Cl. CPC B60L 53/62

(57) ABSTRACT

A charging system is provided with charging devices. The charging system includes an information processor and an information outputter. The information processor is configured to, when an attempt of charging at any one of the charging devices ends in a charging failure, collect environment information on the occasion of the charging failure that is information regarding an outside air temperature and an amount of solar radiation at the relevant one of the charging devices. The information processor is configured to make estimation of availability or unavailability of charging at each timing with respect to the charging devices provided at respective spots, based on the collected environment information, and environment information on the occasion of the estimation indicating the outside air temperature and the amount of solar radiation at each spot and at each estimation. The information outputter is configured to output information regarding the availability or the unavailability of charging.

### TECHNICAL FIELD

The invention relates to a charging system for an electric vehicle, and an electric vehicle.

### BACKGROUND ART

Patent Literature 1 discloses a system that performs information management regarding charging stations to charge a battery of an electric vehicle, and transmits information regarding the number of available chargers to an electronic device on user side.

### CITATION LIST

### Patent Literature

Patent Literature 1: Japanese Unexamined Patent Application Publication No. 2019-176717

### SUMMARY OF INVENTION

### Problem to be Solved by the Invention

Charging devices may sometimes fall into an abnormal state for some reason, e.g., a failure in a start of charging, particularly when the charging devices are installed outdoors. What is desired by an electric vehicle planning to perform charging is to avoid moving toward a charging device unavailable for the start of charging.

An object of the invention is to provide a charging system for an electric vehicle, and an electric vehicle that make it possible to suppress an electric vehicle planning to perform charging from moving toward a charging device unavailable for a start of charging.

### Means for Solving the Problem

A charging system according to an aspect of the invention is a charging system for an electric vehicle provided with charging devices. The charging system includes:
an information processor configured to, when an attempt of charging by the electric vehicle at any one of the charging devices ends in a charging failure, collect environment information on an occasion of the charging failure that is information regarding an outside air temperature and an amount of solar radiation at the relevant one of the charging devices; and
an information outputter, in which
the information processor is configured to make estimation of availability or unavailability of charging at each timing with respect to the charging devices provided at respective spots, based on the collected environment information on the occasion of the charging failure, and environment information on an occasion of the estimation indicating the outside air temperature and the amount of solar radiation at each spot and at each timing at which the estimation is made, and
the information outputter is configured to output information regarding the availability or the unavailability of charging estimated by the information processor.

An electric vehicle according to an aspect of the invention is an electric vehicle including a communicator configured to communicate with an external information processor and an information outputter, and configured to perform charging at each of charging devices, in which
the communicator is configured to receive, from the information processor, information regarding availability or unavailability of charging at the charging devices estimated based on an outside air temperature and an amount of solar radiation, and when an attempt of charging at any one of the charging devices ends in a charging failure, transmit information regarding the charging failure to the information processor, and
the information outputter is configured to output the information regarding the availability or the unavailability of charging received by the communicator.

An electric vehicle according to an aspect of the invention is an electric vehicle including a communicator configured to receive information from outside, an information processor, and an information outputter, and configured to perform charging at each of charging devices, in which
the information processor is configured to
   acquire environment information on an occasion of a charging failure that is information regarding an outside air temperature and an amount of solar radiation when an attempt of charging at any one of the charging devices ends in the charging failure, the communicator is configured to
   receive, from the outside, the environment information on the occasion of the charging failure acquired when an attempt of charging by a random electric vehicle ends in the charging failure,
the information processor is configured to
   make estimation of availability or unavailability of charging at each timing with respect to the charging devices provided at respective spots, based on the acquired environment information on the occasion of the charging failure, and the environment information on the occasion of the charging failure received by the communicator and environment information on an occasion of estimation indicating an outside air temperature and an amount of solar radiation at each spot and at each timing at which the estimation is made, and
the information outputter is configured to output information regarding the availability or the unavailability of charging estimated by the information processor.

An electric vehicle according to an aspect of the invention is an electric vehicle including a communicator configured to receive information from outside and an information outputter, and configured to perform charging at each of charging devices, in which
when any one of the charging devices has possibility of a charging failure, and a privilege is to be granted upon an attempt of charging at the relevant one of the charging devices,
the communicator is configured to receive, from the outside, information regarding the possibility of the charging failure and granting of the privilege, and
the information outputter is configured to output the information received.

### Effects of the Invention

According to the invention, it is possible for a system of an electric vehicle planning to perform charging or a user of the electric vehicle to receive the information regarding the availability or the unavailability of charging with respect to charging devices. Hence, it is possible to suppress the electric vehicle described above from moving toward the charging device unavailable for charging.

### BRIEF DESCRIPTION OF DRAWINGS

FIG. 1 is a block diagram illustrating an electric vehicle and a charging system according to an embodiment of the disclosure.

FIG. 2 is a flowchart illustrating control processing to be carried out by an information processor on client side.

FIG. 3A is a part of a flowchart illustrating control processing to be carried out by an information processor on server side.

FIG. 3B is a remaining part of the flowchart illustrating the control processing in FIG. 3A.

FIG. 4 is a diagram for description of an example of a data map to be generated in the information processor on the server side.

FIG. 5A is a graph illustrating a charging-unavailable region with a piece of environment information regarding a charging failure in Embodiment 1.

FIG. 5B is a graph illustrating the charging-unavailable region with two pieces of the environment information regarding the charging failure in Embodiment 1.

FIG. 5C is a graph illustrating the charging-unavailable region with three pieces of the environment information regarding the charging failure in Embodiment 1.

FIG. 5D is a graph illustrating the charging-unavailable region with four pieces of the environment information regarding the charging failure in Embodiment 1.

FIG. 6A is a graph illustrating the charging-unavailable region with a piece of the environment information regarding the charging failure in Embodiment 2.

FIG. 6B is a graph illustrating the charging-unavailable region with two pieces of the environment information regarding the charging failure in Embodiment 2.

FIG. 6C is a graph illustrating the charging-unavailable region with three pieces of the environment information regarding the charging failure in Embodiment 2.

FIG. 6D is a graph illustrating the charging-unavailable region with four pieces of the environment information regarding the charging failure in Embodiment 2.

### MODES FOR CARRYING OUT THE INVENTION

In the following, some embodiments of the invention are described in detail with reference to the drawings.

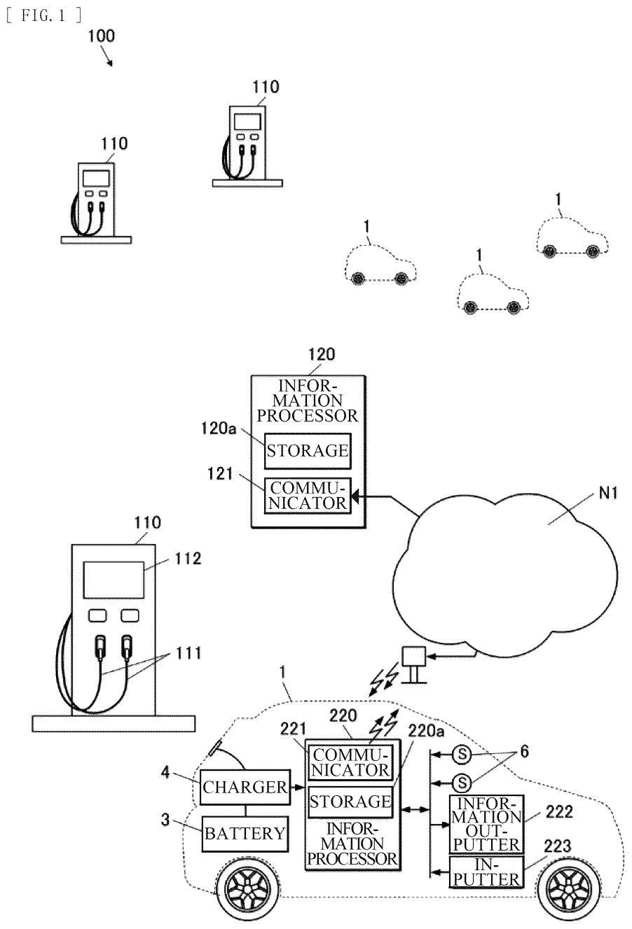

FIG. 1 is a block diagram illustrating an electric vehicle and a charging system according to an embodiment of the invention. A charging system 100 according to the embodiment of the invention includes charging devices 110, an information processor 120 on server side, and an information processor 220 on client side. The information processor 120 on the server side performs management of the charging devices 110. The information processor 220 on the client side is mounted on an electric vehicle 1. The charging devices 110 are provided at various locations.

The information processors 120 and 220 are configured to communicate with communicators (communication modules) 121 and 221 through a communication network N1. The information processor 120 is a computer that operates in accordance with a control program held in a storage 120a. The information processor 220 is a computer that operates in accordance with a control program held in a storage 220a.

To the information processor 220 on the client side, an information outputter (for example, a display) 222 and an inputter (for example, a touchscreen) 223 are coupled. The information outputter 222 outputs information to a user or a system of the electric vehicle 1. The inputter 223 accepts an input of a request from the user.

The electric vehicle 1 includes a battery 3, a charger 4, the information processor 220 mentioned above, and a measurer 6. The battery 3 accumulates electric power for travel. The charger 4 takes electric power from outside and charges the battery 3. The information processor 220 performs information processing related to the use of the charging devices 110. The measurer 6 measures an outside air temperature and an amount of solar radiation. The information outputter 222 and the inputter 223 of the information processor 220 is available to an occupant of the electric vehicle 1.

The charging device 110 is provided with a charging cable 111 and a payment system 112. The charging cable 111 performs electric power transmission to the electric vehicle 1. The payment system 112 is configured to transfer a fee. It is to be noted that a method of electric power transmission from the charging device 110 to the electric vehicle 1 is not limited to the method through the charging cable 111, but a non-contact power transmission method of performing electric power transmission by using an electromagnetic action may be adopted.

The electric vehicle 1 is configured to charge the battery 3 by moving to a spot where the charging device 110 is provided and receiving electric power from the charging device 110 through the charger 4. Meanwhile, for example, at a high temperature and with a large amount of solar radiation, the charging device 110 may sometimes fall into a charging failure, e.g., a failure in a start of charging, for example, when the payment system 112 of the charging device 110 stops because of overheating.

### Operation of Electric Vehicle

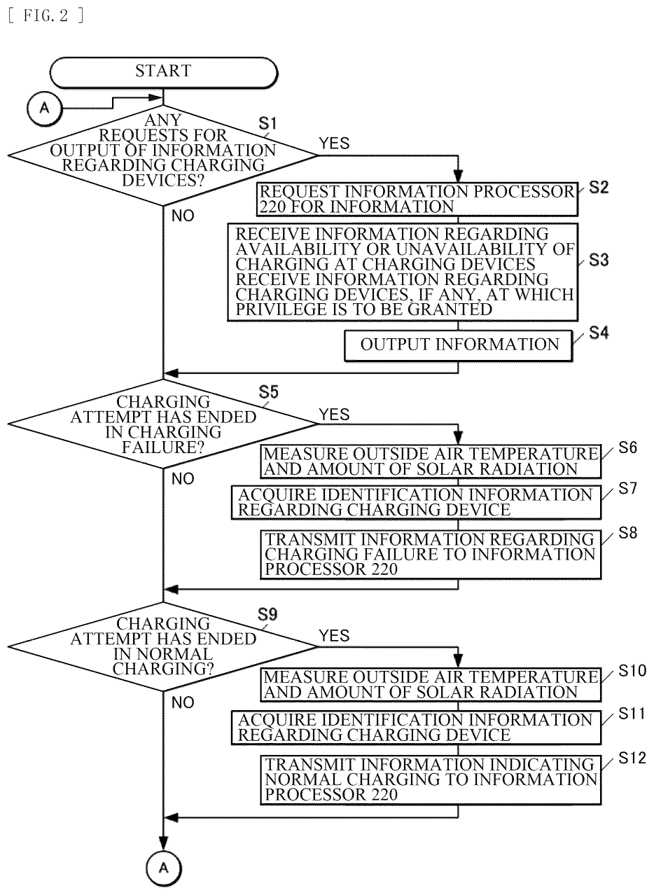

FIG. 2 is a flowchart illustrating control processing to be carried out by the information processor of the electric vehicle. The information processor 220 carries out the control processing during system operation of the electric vehicle 1. In the control processing, the information processor 220 repetitively carries out loop processing (steps S1, S5, and S9) of determining whether an applicable event has occurred. In the loop processing, first, the information processor 220 determines presence or absence of any requests from the user for an output of information regarding the charging devices 110 (step S1). The request for the output of the information may be issued by the user from, for example, the inputter 223 of the information processor 220.

As a result of a determination in step S1, when the request to output the information is present, the information processor 220 makes a request for the information to the information processor 120 on the server side through communication (step S2), and receives information regarding availability or unavailability of charging at the charging devices 110 at various locations, from the information processor 120 (step S3). The information regarding the availability or the unavailability of charging includes identification information regarding each of the charging devices 110 and information regarding the availability or the unavailability of charging at the relevant one of the charging devices 110 in association with each other.

As described in detail later, the charging devices 110 may sometimes include the charging device 110 that has possibility of the charging failure but at which a privilege is to be granted upon an attempt of charging by the user. In such a case, the information regarding the availability or the unavailability of charging to be sent from the information processor 120 to the charging device 110 includes information regarding the charging device 110 at which the privilege mentioned above is to be granted. That is, in the above-described case, the information regarding the availability or the unavailability of charging includes the identification information regarding the charging device 110 at which the privilege is to be granted and the information indicating that the privilege is to be granted, in association with each other.

Moreover, the information processor 220 outputs the information regarding the availability or the unavailability of charging with respect to the charging devices 110 at various locations, through the information outputter 222 (step S4). There is no particular limitation on an output method of the information, but a method may be adopted that includes, for example, displaying icons of the charging devices 110 in superimposition on map display, and superimposing display indicating the unavailability of charging, on the charging device 110 unavailable for charging. Alternatively, as the output method of the information regarding the availability or the unavailability of charging, a method may be adopted that includes providing list display of various kinds of information such as names, locations, and fees of the charging devices 110, and displaying information regarding the unavailability of charging in the list of the charging devices 110 unavailable for charging. Alternatively, in the list display mentioned above, a method may be adopted that includes, for example, excluding the display of the charging devices unavailable for charging from the list. Moreover, when the charging devices 110 include the charging device 110 at which the privilege is to be granted, an output of the information indicating that the privilege is to be granted is added in association with the relevant charging device 110.

It is to be noted that the device that communicates with the information processor 120 on the server side to perform the processing of steps S1 to S4 is not limited to the information processor 220 provided in the electric vehicle 1, but may be a portable terminal carried by the user. After step S4, the information processor 220 causes the processing to return to the loop processing of determining the occurrence of the event.

In the loop processing, the information processor 220 further determines whether an attempt of charging at any one of the charging devices 110 has ended in the charging failure (step S5). When a result of the determination in step S5 is YES, the information processor 220 acquires information regarding the outside air temperature and the amount of solar radiation measured by the measurer 6 of the electric vehicle 1 (step S6). Moreover, the information processor 220 acquires the identification information regarding the charging device 110 from the charger 4 (step S7). Thus, the information processor 220 transmits, to the information processor 120 on the server side, through the communicator 221, the identification information regarding the charging device 110 having the charging failure, environment information on the occasion of the charging failure, and information indicating the charging failure, in association with one another (step S8). The environment information on the occasion of the charging failure is the information regarding the outside air temperature and the amount of solar radiation. Thus, the information processor 220 causes the processing to return again to the loop processing of determining the occurrence of the event.

In the loop processing, the information processor 220 further determines whether an attempt of charging at the charging device 110 has ended in normal charging (step S9). When a result of the determination in step S9 is YES, the information processor 220 acquires the information regarding the outside air temperature and the amount of solar radiation measured by the measurer 6 of the electric vehicle 1 (step S10). Moreover, the information processor 220 acquires the identification information regarding the charging device 110 from the charger 4 (step S11). Thus, the information processor 220 transmits, to the information processor 120 on the server side, through the communicator 221, the identification information regarding the charging device 110 at which the charging has been normally started, environment information on the occasion of the normal charging, and information indicating the normal charging, in association with one another (step S12). The environment information on the occasion of the normal charging is the information regarding the outside air temperature and the amount of solar radiation. Thus, the information processor 220 causes the processing to return again to the loop processing of determining the occurrence of the event. It is to be noted that the processing of steps S9 to S12 may be omitted.

A program of the control processing described above is held in a non-transitory storage medium (non-transitory computer readable medium) such as the storage 220a of the information processor 220. The information processor 220 may be configured to read a program held in a portable non-transitory recording medium and execute the program. The portable non-transitory storage medium mentioned above may hold the program of the control processing described above.

### Operation on the Server Side

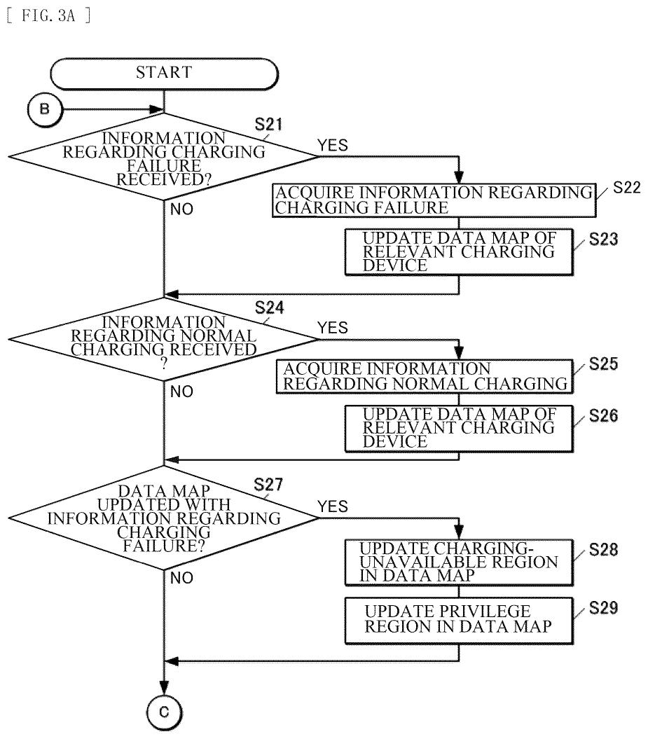

FIGS. 3A and 3B are flowcharts illustrating control processing to be carried out by the information processor on the server side. The information processor 120 on the server side repetitively carries out loop processing (steps S21, S24, S30, and S34) to determine whether an applicable event has occurred. In the loop processing, first, the information processor 120 determines whether the information regarding the charging failure has been received from the electric vehicle 1 (step S21). As a result, when the information has been transmitted, the information processor 120 acquires the information (step S22), and updates a data map in which the information regarding the availability or the unavailability of charging at each of the charging devices 110 is collected, based on the identification information regarding the charging device 110 included in the information (step S23). Thereafter, the information processor 120 causes the processing to return to the loop processing of determining the occurrence of the event.

In the loop processing, the information processor 120 determines whether the information regarding the normal charging has been received from the electric vehicle 1 (step S24). As a result, when the information has been received, the information processor 120 acquires the information (step S25), and updates the data map in which the information regarding the availability or the unavailability of charging at the charging device 110 included in the information is collected (step S26). Thereafter, the information processor 120 causes the processing to return to the loop processing of determining the occurrence of the event.

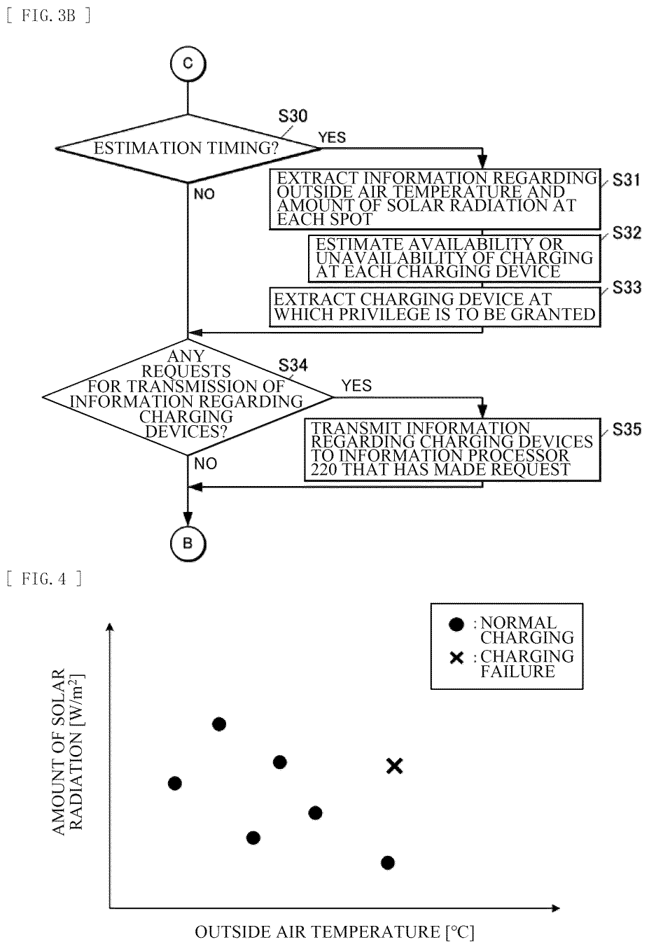

FIG. 4 is a diagram for description of the data map in which the information regarding the availability or the unavailability of charging at each charging device is collected. In the information processor 120, the single data map is generated for each charging device 110. As illustrated in FIG. 4, the data map is a map in which the environment information is collected that is data regarding the outside air temperature and the amount of solar radiation on the occasion of the normal charging and on the occasion of the charging failure. The environment information is data obtained upon the attempts of charging at the charging device 110 by the electric vehicles 1.

It is to be noted that the data map mentioned above includes the information on the occasion of the normal charging. However, the data map may not include information on the occasion of the normal charging. In the following, an example is given in which the information on the occasion of the normal charging is included in the data map. As illustrated in FIG. 4, in a graphical representation of the information in the data map, the normal charging and the charging failure are plotted on two coordinate axes denoting the outside air temperature and the amount of solar radiation.

In the loop processing of determining the occurrence of the event, the information processor 120 determines whether the data map has been updated based on the information regarding the charging failure (step S27). As a result, when YES, the information processor 120 updates, in the data map, a region of the outside air temperature and the amount of solar radiation in which estimation of the unavailability of charging is made (hereinafter, referred to as a “charging-unavailable region”) (step S28).

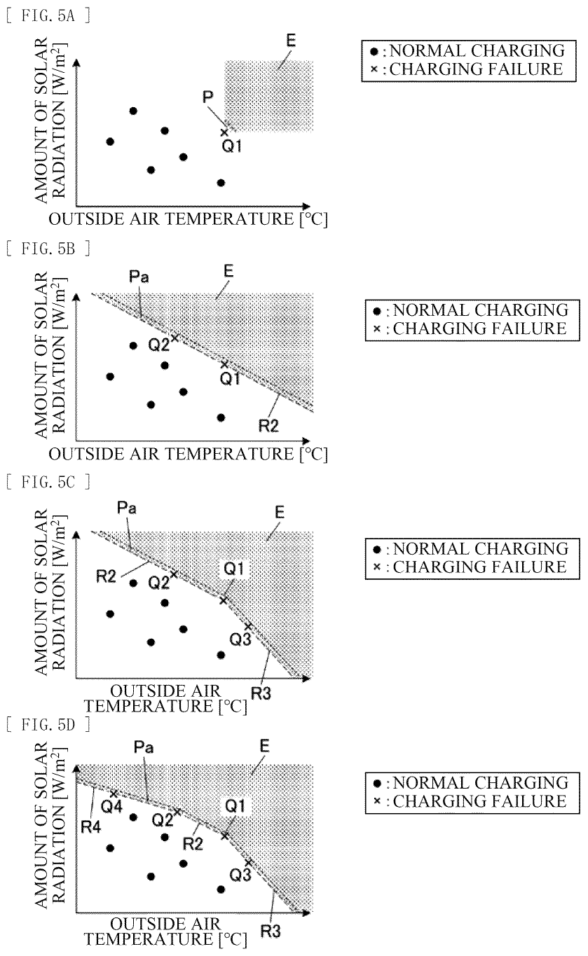

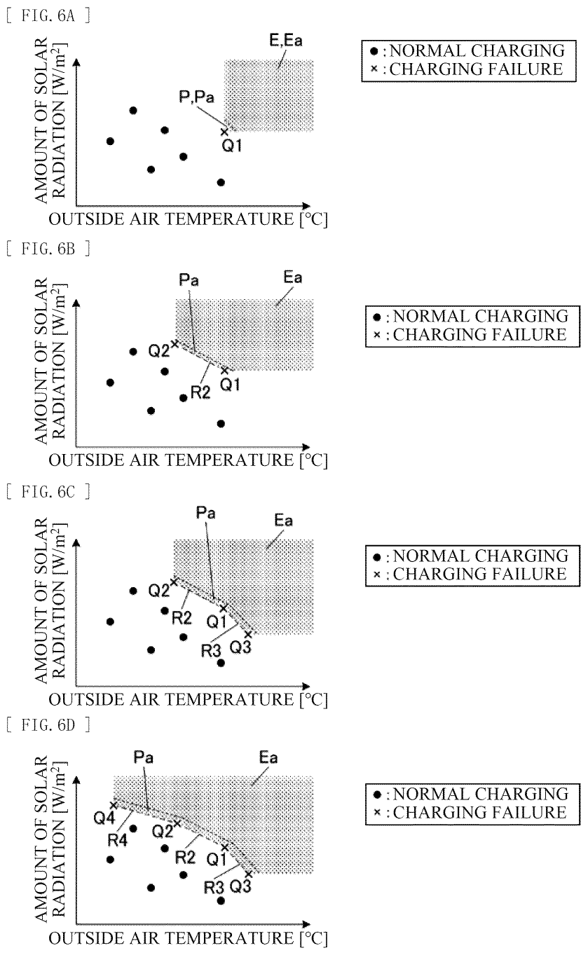

FIGS. 5A to 5D are graphs illustrating examples of the charging-unavailable region set in accordance with the environment information regarding the charging failure in Embodiment 1. FIGS. 6A to 6D are graphs illustrating examples of the charging-unavailable region set in accordance with the environment information regarding the charging failure in Embodiment 2. Embodiment 1 is an example in which a charging-unavailable region E is set by performing extrapolation. Embodiment 2 is an example in which a charging-unavailable region Ea is set by performing interpolation.

As illustrated in FIG. 5A, when there is one point (i.e., plot Q1) for the environment information regarding the charging failure in the data map, the information processor 120 assumes, as the charging-unavailable region E, a region in which the outside air temperature is higher than the outside air temperature in the relevant piece of the environment information and the amount of solar radiation is larger than the amount of solar radiation in the relevant piece of the environment information.

It is to be noted that the environment information measured on the occasion of the charging failure usually does not include boundary values separating the normal charging from the charging failure, but often has the outside air temperature somewhat higher than the boundary and the amount of solar radiation somewhat larger than the boundary. That is, there is usually a difference between the boundary separating the availability of charging from the unavailability of charging and the environment information measured on the occasion of the charging failure. Accordingly, in consideration of the difference, the charging-unavailable region E may be assumed to be a region beyond the outside air temperature somewhat lower than the environment information measured on the occasion of the charging failure, and beyond the amount of solar radiation somewhat smaller than the environment information measured on the occasion of the charging failure. In the following, an example is given in which the difference mentioned above is not taken into consideration.

As illustrated in FIGS. 5B to 5D, when there are points (i.e., plots Q1 to Q4) for the environment information regarding the charging failure in the data map, the information processor 120 performs the extrapolation with respect to the plots Q1 to Q4. The extrapolation provides many pieces of the environment information that are unobserved but is predicted to have the charging failure. The many pieces of the environment information correspond to respective points on straight lines R2 to R4 coupling together the plots Q1 to Q4. After calculating the straight lines R2 to R4 by the extrapolation, the information processor 120 assumes, as the charging-unavailable region E, a region where the outside air temperature is higher than each point on the straight lines R2 to R4 and the amount of solar radiation larger than each point on the straight lines R2 to R4.

In the forgoing example, an example is given in which the extrapolation is performed when there are points for the environment information regarding the charging failure. However, as illustrated in FIGS. 6B to 6D, interpolating may be replaced with the interpolation. In the case of the interpolation, the charging-unavailable region Ea is set that is obtained by removing a portion from the charging-unavailable region E in the case of the extrapolation. A half of the removed portion mentioned above is a region where the outside air temperature is lower than a piece of the environment information (for example, the plot Q4 in FIG. 6D) in which the outside air temperature goes lowest and the amount of solar radiation goes largest, out of the pieces of the environment information regarding the charging failure. The other half of the portion mentioned above is a region where the amount of solar radiation is smaller than a piece of the environment information (for example, the plot Q3 in FIG. 6D) in which the outside air temperature goes highest and the amount of solar radiation goes smallest, out of the pieces of the environment information regarding the charging failure.

Even when the extrapolation or the interpolation is performed, there is often a difference between the boundary that separates the normal charging from the charging failure from the many pieces of the environment information obtained by the interpolating. Accordingly, even when the extrapolation or the interpolation is performed, in consideration of the difference, the charging-unavailable regions E and Ea may be set to a region beyond the outside air temperature somewhat lower than the straight lines R2 to R4 obtained by the interpolating, and beyond the amount of solar radiation somewhat smaller than the straight lines R2 to R4 obtained by the interpolating.

After updating the charging-unavailable regions E and Ea, the information processor 120, next, updates regions P and Pa in which there is possibility of the charging failure but the privilege is to be granted upon the attempt of charging by the user (hereinafter, referred to as “privilege regions”) (step S29). In FIGS. 5A to 5D, and FIGS. 6A to 6D, the privilege regions P and Pa are indicated by regions sandwiched by broken lines. The charging-unavailable regions E and Ea mentioned above are regions in which the estimation of the unavailability of charging is made when both the outside air temperature and the solar radiation are included in the regions. But there is possibility that in fact the charging is available even in the charging-unavailable regions E and Ea. However, if no attempts of charging are made in the charging-unavailable regions E and Ea, it is impossible to find a region in which in fact the charging is available. Thus, it is desired to enrich data in the data map to make it possible to make the estimation of the availability or the unavailability of charging with higher accuracy. To make the estimation of the availability or the unavailability of charging with higher accuracy, it is desired to enrich data near the boundary separating the availability of charging from the unavailability of charging. To answer such a request, the information processor 120 sets the privilege regions P and Pa in which the user is encouraged to make the attempt of charging, and in return, the privilege is granted to the user. There is no particular limitation on the privilege mentioned above, but various modes may be applicable, e.g., reduction in charging fees and granting of valuable points.

As illustrated in FIGS. 5A to 5D, and FIGS. 6A to 6D, the information processor 120 sets, as the privilege regions P and Pa, a region of a predetermined range from the boundary between the availability and the unavailability of charging (a boundary with a constant outside air temperature and a boundary with a constant amount of solar radiation may be excluded), within the charging-unavailable regions E and Ea. The predetermined range mentioned above may be a range of a preset scope of the outside air temperature and a range of a preset scope of the amount of solar radiation in which possibility of the availability of charging is left to some extent even if it is determined that the charging is unavailable. In step S29, the information processor 120 updates the privilege regions P and Pa in accordance with the charging-unavailable regions E and Ea updated in step S28. Thereafter, the information processor 120 causes the processing to return to the loop processing of determining the occurrence of the event.

In the loop processing, the information processor 120, next, determines whether it is predetermined estimation timing (step S30). The estimation timing may be set to, for example, cycles of updates of weather information. As a result, when it is determined in affirmation (YES) in step S30, the information regarding the outside air temperatures and the amounts of solar radiation at spots where the charging devices 110 are located is extracted from the weather information regarding various locations, as the environment information on the occasion of the estimation (step S31). Thus, the information processor 120 applies the environment information on the occasion of the estimation to the data map of each of the charging devices 110, to estimate the availability or the unavailability of charging at each of the charging devices 110 (step S32). That is, when the outside air temperature and the amount of solar radiation as the environment information on the occasion of the estimation are included in the charging-unavailable region E, the information processor 120 makes the estimation of the unavailability of charging. Furthermore, the information processor 120 applies the environment information on the occasion of the estimation to the data map of each of the charging devices 110, and determines whether the environment information regarding each of the charging devices 110 is included in the privilege regions P and Pa (step S33). That is, the information processor 120 extracts the charging device 110 at which the privilege is to be granted upon the attempt of charging. Thereafter, the information processor 120 causes the processing to return to the loop processing of determining the occurrence of the event.

In the loop processing, the information processor 120, next, determines presence or absence of any requests for the transmission of the information regarding the charging devices 110, from the information processor 220 on the client side (step S34). Thus, when it is determined in affirmation (YES) in step S34, the information processor 120 transmits, to the information processor 220 on the client side, the information regarding the charging devices 110 including results of the estimation of the availability or the unavailability of charging in step S32, and information regarding the charging device 110 at which the privilege is to be granted in step S33 (step S34). Thereafter, the information processor 120 causes the processing to return to the loop processing of determining the occurrence of the event.

The information processor 120 on the client side receives the information regarding the charging devices 110 transmitted in step S24 by the control processing in FIG. 2 described above, and outputs the information to the user (for example, the occupant of the electric vehicle 1). This makes it possible to suppress the user from moving rashly for charging by the electric vehicle 1 to the charging device 110 having high possibility of the charging failure. Moreover, when the charging device 110 is present that has the possibility of the charging failure but at which the privilege is to be granted upon the attempt of charging, it is possible for the user to recognize that.

The program of the control processing described above is held in a non-transitory storage medium such as the storage 120a of the information processor 120. The information processor 120 may be configured to read a program held in a portable non-transitory recording medium and execute the program. The portable non-transitory storage medium may hold the program of the control processing described above.

As described above, according to the charging system 100 of the embodiment, the charging devices 110 are provided. Furthermore, the charging system 100 includes the information processor 120 configured to collect, when the attempt of charging by the electric vehicle 1 at any one of the charging devices 110 ends in the charging failure, the environment information on the occasion of the charging failure that is the information regarding the outside air temperature and the amount of solar radiation at the relevant one of the charging devices 110. Furthermore, the charging system 100 includes the information outputter 222 available to the user. Moreover, the information processor 120 is configured to make the estimation of the availability or the unavailability of charging at each timing with respect to the charging devices 110 provided at the respective spots, based on the collected environment information on the occasion of the charging failure, and the environment information on the occasion of the estimation indicating the outside air temperature and the amount of solar radiation at each spot and at each timing at which the estimation is made. Hence, it is possible for the information processor 120 to make the realistic estimation of the availability or the unavailability of charging based on the information collected during normal operation of the charging devices 110. Furthermore, the information outputter 222 outputs the information regarding the availability or the unavailability of charging estimated by the information processor 120. Hence, based on the result of the estimation, it is possible to suppress the user from moving the electric vehicle 1 to be charged toward the charging device 110 at which the charging is unavailable.

The installation locations of the charging devices 110 have different characteristics such as good ventilation or direct sunlight. In such a case, even at the same outside air temperature and with the same amount of solar radiation, for example, the charging failure occurs at one of the charging devices 110 while the normal charging is available at another of the charging devices 110. Thus, the boundary value between the availability and the unavailability of charging may vary for each charging device 110.

Thus, according to the charging system 100 of the embodiment, the information processor 120 is configured to generate the data map in which the environment information on the occasion of the charging failure is collected for each charging device 110, and make the estimation of the availability or the unavailability of charging at each charging device 110 by using the data map of each charging device 110. In other words, when any one of the charging devices 110 is assumed to be called the first charging device 110, the information processor 120 is configured to collect the information regarding the outside air temperature and the amount of solar radiation on the occasion of the charging failure at the first charging device 110 (that is, the environment information on the occasion of the charging failure) in association with the identification information regarding the first charging device 110. Thus, the information processor 120 is configured to generate the data map in which the environment information on the occasion of the charging failure associated with the first charging device 110 is collected, in corresponding relation to the first charging device 110, and make the estimation of the availability or the unavailability of charging at the first charging device 110 based on the data map. With this configuration, it is possible for the information processor 120 to make the estimation of the availability or the unavailability of charging at each of the charging devices 110, in accordance with the characteristics of the installation location of each of the charging devices 110. Hence, it is possible for the user to acquire the accurate result of the estimation of the availability or the unavailability of charging at each of the charging devices 110.

It is to be noted that, when it is known that several charging devices 110 are installed in the same environment, the information processor 120 may gather the environment information on the occasion of the charging failure at the several charging devices 110 to generate the single data map. Thus, the information processor 120 may make the estimation of the availability or the unavailability of charging at the several charging devices 110 based on the data map.

Furthermore, according to the charging system 100 of the embodiment, when there are pieces of the environment information on the occasion of the charging failure, the information processor 120 is configured to make the estimation of the unavailability of charging based on the interpolated environment information obtained by the interpolating (interpolated environment information). That is, the information processor 120 allows a range of the environment information regarding the estimation of the unavailability of charging, to include the range of the higher outside air temperature and the larger amount of solar radiation than the interpolated environment information. With such processing, it is possible to make the estimation of the availability or the unavailability of charging within various ranges of the environment information even when the amount of collection of the environment information on the occasion of the charging failure is small.

In a situation in which the outside air temperature is high and the amount of solar radiation is large and the charging failure occurs at the charging device 110, there is possibility that other components of the charging device 110 (e.g., various measurers, communication devices, etc.) also have an abnormality. Thus, according to the charging system 100 of the embodiment, the measurer 6 of the electric vehicle 1 is configured to measure the environment information on the occasion of the charging failure (outside air temperature and amount of solar radiation), and the environment information measured by the measurer 6 is transmitted to the information processor 120 from the electric vehicle 1. With such a configuration, it is possible for the information processor 120 to reduce occurrence of a situation in which the environment information on the occasion of the charging failure becomes unacquirable because of the abnormality.

Furthermore, according to the charging system 100 of the embodiment, with respect to the charging device 110 at which the estimation of the unavailability of charging is made, when the environment information on the occasion of the estimation is within the predetermined range from the boundary that separates the availability of charging from the unavailability of charging, the information outputter 222 is configured to output the information indicating that the privilege is to be granted upon the attempt of charging by the user. Specifically, when the environment information on the occasion of the estimation is in the privilege regions P and Pa, the information processor 120 is configured to transmit the information indicating that the privilege is to be granted, and the information outputter 222 is configured to output the information. With such a configuration, it is possible to motivate the user who intends to attempt charging at the charging device 110 at which the outside air temperature and the amount of solar radiation are near the boundary that separates the availability of charging from the unavailability of charging. Hence, it is possible for the information processor 120 to acquire a large amount of the information regarding the availability or the unavailability of charging around the boundary, and a large amount of the environment information when the attempt of charging is made. This leads to enhancement in accuracy of the estimation of the availability or the unavailability of charging.

As described above, according to the electric vehicle 1 of the embodiment, the electric vehicle 1 includes the communicator 221 and the information outputter 222. The communicator 221 is configured to communicate with the information processor 120. Moreover, when the attempt of charging at any one of the charging devices 110 ends in the charging failure, the communicator 221 is configured to transmit the information regarding the charging failure to the information processor 120. Furthermore, the communicator 221 is configured to receive, from the information processor 120, the information regarding the availability or the unavailability of charging at the charging device 110 estimated based on the outside air temperature and the amount of solar radiation. The information outputter 222 is configured to output the information. With such a configuration of the electric vehicle 1, it is possible to realize the estimation processing of the availability or the unavailability of charging at the charging devices 110 by the information processor 120, and the processing of notifying the user on board the electric vehicle 1 of the result of the estimation.

Furthermore, according to the electric vehicle 1 of the embodiment, when the attempt of charging at the charging device 110 ends in the charging failure, the communicator 221 is configured to transmit, to the information processor 120, the environment information on the occasion of the charging failure, in addition to the information regarding the charging failure. The environment information on the occasion of the charging failure is the information regarding the outside air temperature and the amount of solar radiation. With such a configuration of the electric vehicle 1, it is possible for the information processor 120 to collect the environment information on the occasion of the charging failure, while avoiding any failures even in a severe environment.

Although the charging system 100 and the electric vehicle 1 of the embodiment have been described in the forgoing, the charging system and the electric vehicle according to the invention is not limited to the configurations of the forgoing embodiments. For example, in the forgoing embodiment, the configuration is described in which the information processor 120 on the server side collects the environment information on the occasion of the charging failure, and makes the estimation of the availability or the unavailability of charging at the charging devices based on the environment information on the occasion of the charging failure and the environment information on the occasion of the estimation. However, the forgoing processing of collecting the environment information and making the estimation of the availability or the unavailability of charging may be carried out by the information processor 220 mounted on the electric vehicle 1. In this case, the information processor 220 may communicate with a random electric vehicle 1 and receive the environment information when the attempt of charging by the random electric vehicle 1 ends in the charging failure, to collect the environment information on the occasion of the charging failure. Furthermore, as with the case of the forgoing embodiment, the information processor 220 may generate the data map for each charging device 110, and based on the data map, make the estimation of the availability or the unavailability of charging at the charging device 110 associated with the data map. Even with such a configuration, it is possible to obtain similar effects to those of the forgoing embodiment.

Moreover, when the charging device 110 is present that has the possibility of the charging failure but at which the privilege is to be granted upon the attempt of charging, the electric vehicle 1 may be configured to receive, from the outside, the information regarding the charging device 110 at which the privilege is to be granted, and allow the information outputter 222 to output the information. The electric vehicle 1 does not have to have the function of receiving the information regarding the availability or the unavailability of charging at the charging devices 110 or outputting the information. According to such an electric vehicle 1, it is possible to motivate the user who intends to attempt charging at the charging device 110 at which the outside air temperature and the amount of solar radiation are around the boundary that separates the availability of charging from the unavailability of charging. Hence, it is possible for the information processor 120 to acquire a large amount of the information regarding the availability or the unavailability of charging around the boundary mentioned above, and a large amount of the environment information. This leads to the enhancement in the accuracy of the estimation of the availability or the unavailability of charging.

In addition, the details described in the forgoing embodiment may be changed as appropriate without departing from the scope of the invention.

### INDUSTRIAL APPLICABILITY

The invention is usable for a charging system for an electric vehicle, and an electric vehicle.

### DESCRIPTION OF REFERENCE NUMERALS

1 Electric vehicle
3 Battery
4 Charger
6 Measurer
100 Charging system
110 Charging device
111 Charging cable
112 Payment system
120, 220 Information processor
120a, 220a Storage
121, 221 Communicator
222 Information outputter
223 Inputter
E, Ea Charging-unavailable region
P, Pa Privilege region
Q1 to Q4 Plot
R2 to R4 Straight line

1. A charging system for an electric vehicle provided with charging devices, the charging system comprising:
an information processor configured to, when an attempt of charging by the electric vehicle at any one of the charging devices ends in a charging failure, collect environment information on an occasion of the charging failure that is information regarding an outside air temperature and an amount of solar radiation at the relevant one of the charging devices; and
an information outputter, wherein
the information processor is configured to make estimation of availability or unavailability of charging at each timing with respect to the charging devices provided at respective spots, based on the collected environment information on the occasion of the charging failure, and environment information on an occasion of the estimation indicating the outside air temperature and the amount of solar radiation at each spot and at each timing at which the estimation is made, and
the information outputter is configured to output information regarding the availability or the unavailability of charging estimated by the information processor.

2. The charging system for the electric vehicle according to claim 1, wherein
the information processor is configured to, when any one of the charging devices is assumed to be called a first charging device,
collect the environment information on the occasion of the charging failure at the first charging device, in association with the first charging device,
generate a data map in which the environment information on the occasion of the charging failure associated with the first charging device is collected, in corresponding relation to the first charging device, and
make the estimation of the availability or the unavailability of charging at the first charging device based on the data map corresponding to the first charging device.

3. The charging system for the electric vehicle according to claim 2, wherein
the information processor is configured to, when pieces of the environment information on the occasion of the charging failure are present,
allow a range of the outside air temperature and the amount of solar radiation in which the estimation of the unavailability of charging is made, to include a range of a higher outside air temperature and a larger amount of solar radiation than each of the pieces of the environment information on the occasion of the charging failure, and a range of a higher outside air temperature and a larger amount of solar radiation than each piece of interpolated environment information obtained by interpolating the pieces of the environment information on the occasion of the charging failure.

4. The charging system for the electric vehicle according to claim 1, wherein
the electric vehicle comprises a measurer configured to measure the outside air temperature and the amount of solar radiation, and
the environment information on the occasion of the charging failure comprises information measured by the measurer.

5. The charging system for the electric vehicle according to claim 1, wherein,
with respect to any one of the charging devices at which the estimation of the unavailability of charging is made, the information outputter is configured to, when the environment information on the occasion of the estimation is within a predetermined range from a boundary that separates the availability of charging from the unavailability of charging,
output information indicating that a privilege is to be granted upon the attempt of charging by a user.

6. An electric vehicle comprising a communicator configured to communicate with an external information processor and an information outputter, and configured to perform charging at each of charging devices, wherein
the communicator is configured to receive, from the information processor, information regarding availability or unavailability of charging at the charging devices estimated based on an outside air temperature and an amount of solar radiation, and when an attempt of charging at any one of the charging devices ends in a charging failure, transmit information regarding the charging failure to the information processor, and
the information outputter is configured to output the information regarding the availability or the unavailability of charging received by the communicator.

7. The electric vehicle according to claim 6, wherein
the communicator is configured to, when the attempt of charging at any one of the charging devices ended in the charging failure,
transmit, to the information processor, the information regarding the charging failure and environment information on the occasion of the charging failure that is information regarding the outside air temperature and the amount of solar radiation.

8. An electric vehicle comprising a communicator configured to receive information from outside, an information processor, and an information outputter, and configured to perform charging at each of charging devices, wherein
the information processor is configured to
acquire environment information on an occasion of a charging failure that is information regarding an outside air temperature and an amount of solar radiation when an attempt of charging at any one of the charging devices ends in the charging failure,
the communicator is configured to
receive, from the outside, the environment information on the occasion of the charging failure acquired when an attempt of charging by a random electric vehicle ends in the charging failure,
the information processor is configured to
make estimation of availability or unavailability of charging at each timing with respect to the charging devices provided at respective spots, based on the acquired environment information on the occasion of the charging failure, and the environment information on the occasion of the charging failure received by the communicator and environment information on an occasion of estimation indicating an outside air temperature and an amount of solar radiation at each spot and at each timing at which the estimation is made, and
the information outputter is configured to output information regarding the availability or the unavailability of charging estimated by the information processor.

9. The electric vehicle according to claim 8, wherein
the information processor is configured to, when any one of the charging devices is assumed to be called a first charging device,
collect the environment information on the occasion of the charging failure at the first charging device, in association with the first charging device,
generate a data map in which the environment information on the occasion of the charging failure associated with the first charging device is collected, in corresponding relation to the first charging device, and
make the estimation of the availability or the unavailability of charging at the first charging device based on the data map corresponding to the first charging device.

10. An electric vehicle comprising a communicator configured to receive information from outside and an information outputter, and configured to perform charging at each of charging devices, wherein
when any one of the charging devices has possibility of a charging failure, and a privilege is to be granted upon an attempt of charging at the relevant one of the charging devices,
the communicator is configured to receive, from the outside, information regarding the possibility of the charging failure and granting of the privilege, and
the information outputter is configured to output the information received.
